(19) United States
(12) Patent Application Publication
(10) Pub. No.: US 2007/0065205 A1
(43) Pub. Date: Mar. 22, 2007

(54) IMAGE FORMING APPARATUS, AND METHOD OF IMAGE PROCESSING

(75) Inventor: Keiichi Takashima, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/531,767

(22) Filed: Sep. 14, 2006

(30) Foreign Application Priority Data
Sep. 21, 2005 (JP) 2005-274430

(51) Int. Cl. B41J 29/38

(52) U.S. Cl. 400/62

(57) ABSTRACT

An image processing method and apparatus that produces data for printing, wherein the data is based on an image in a first region whose size and shape can vary according to an input of variable data and on a copy-forgery-inhibited pattern which is added to the image that includes setting a second region to which a copy-forgery-inhibited pattern image is provided, wherein the second region is linked to the variance in size or shape of the first region, and producing data for printing based on the copy-forgery-inhibited pattern image in the second region an image in the first region whose size or shape is varied.

### BACKGROUND OF THE INVENTION

1. Field of the Invention

The present invention relates to an image processing apparatus and an image processing method. More specifically, the present invention relates to a processing in which a copy-forgery-inhibited pattern that inhibits copying is combined to a business form and printed. The input region of the business form varies in size according to variable data.

2. Description of the Related Art

Japanese Patent Application Laid-Open No. 08-244389 discusses a printing paper on which a copy-forgery-inhibited pattern image or a copy-forgery-inhibited pattern is provided in advance in order to inhibit copying.

The copy-forgery-inhibited pattern is an image that includes characters and patterns. When a copying machine copies the copy-forgery-inhibited pattern, one part of the image is visible and the other part is not visible.

For example, when the copy-forgery-inhibited pattern is copied, a latent image including the characters and the patterns, such as “copy inhibited”, is made visible. However, only minute patterns are formed as a background.

Thus, when a print product having the copy-forgery-inhibited pattern is copied, the latent image is made visible in order to indicate that the copied product is not an original product. Thus, combining the copy-forgery-inhibited pattern in the print as the background is effective in inhibiting unauthorized copying.

The paper that is provided in advance with the copy-forgery-inhibited pattern is used in printing of information that should not be subject to easy access by copying, such as census registration information.

The printing paper having the copy-forgery-inhibited pattern is also used for printing documents that include confidential information, such as a delivery card and an invoice.

A system has recently been made available in which the paper provided in advance with the above copy-forgery-inhibited pattern is not used, but rather data of contents to be printed is combined with the copy-forgery-inhibited pattern so as to be printed out on an ordinary paper (see Japanese Patent Application Laid-Open No. 2001-197297).

In addition, a system is known in which a business form, such as the delivery card and the invoice, that is to be inhibited by the copy-forgery-inhibited pattern and the copy-forgery-inhibited pattern are printed being linked together (see Japanese Patent Application Laid-Open No. 2001-324898).

In this system, the copy-forgery-inhibited pattern image is applied only to a region of the business form in which, for example, a trade name and a price are described.

Meanwhile, when inputting data into the business form that is previously set up by an application, an amount of data to be inputted into the business form does not necessarily agree with the already set business form.

In this regard, as discussed in Japanese Patent Application Laid-Open No. 2001-324898, a system is known in which the setting is variably performed by changing a size and a shape of the business form at the time of designing it in accordance with the amount of data to be inputted into a predetermined area.

In this manner, for example, when data of seven rows is inputted at the time of printing into a variable data region of five rows, the data corresponding to seven rows can be inputted by automatically changing the size and the number of rows.

However, when the copy-forgery-inhibited pattern image is provided on the variable data region by combining the copy-forgery-inhibited pattern image, if the size of the copy-forgery-inhibited pattern image remains fixed, it cannot appropriately deal with the size and the shape of the variable data region of the business form.

In the business form, there is the variable data region in which information including the price and the trade name is described and to which the copy-forgery-inhibited pattern should be applied.

However, in applying the copy-forgery-inhibited pattern image to the region, if the region is enlarged according to the amount of data to be inputted, the copy-forgery-inhibited pattern cannot be applied to all the regions to which the copy-forgery-inhibited pattern should be applied.

In this case, in terms of a design, the business form does not show a good appearance. In addition, there is concern that a copied product of the region to which the copy-forgery-inhibited pattern is not applied, is used for an unauthorized purpose.

On the other hand, in the system discussed by Japanese Patent Application Laid-Open No. 2001-324898, the size of the copy-forgery-inhibited pattern image is set to be relatively large, and the region to which the copy-forgery-inhibited pattern is applied, cannot be limited, which also causes a problem.

That is, a coloring material such as a toner and an ink is wastefully consumed because the copy-forgery-inhibited pattern image is also applied to the region to which it needs not be applied.

In addition, when a setting of a density parameter of the copy-forgery-inhibited pattern image is fixed, if copying conditions such as a kind of the copying machine and a copying density are different, the latent image cannot be clearly formed, and as a result, the effect of inhibiting the copy of the product cannot be obtained.

Accordingly, a system is desired in which the copy-forgery-inhibited pattern can be appropriately applied corresponding to the variance of the region, such as the business form.

### SUMMARY OF THE INVENTION

The present invention is directed to overcoming the above-described disadvantages of the conventional art.

According to an aspect of the present invention, an image processing apparatus that produces data for printing, wherein the data is based on an image in a first region whose size and shape can vary according to an input of variable data and on a copy-forgery-inhibited pattern which is added to the image includes a region setting unit adapted to set a second region to which a copy-forgery-inhibited pattern image is provided, wherein the second region is linked to the variance in size or shape of the first region, and a production unit adapted to produce data for printing based on the copy-forgery-inhibited pattern image in the second region that is set by the region setting unit and an image in the first region whose size or shape is varied.

According to another aspect of the present invention, an image processing apparatus that produces data for printing, wherein the data is based on an image in a first region whose size or shape can vary according to an input of variable data and on a copy-forgery-inhibited pattern which is added to the image in the first region, includes a production unit adapted to produce data for printing based on a copy-forgery-inhibited pattern image in a region that is linked to the variance in size or shape of the first region and an image in the fist region whose size or shape is varied.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 is a block diagram illustrating a hardware configuration of a client in a copy-forgery-inhibited pattern printing system according to a first exemplary embodiment of the present invention.

FIG. 2 is a diagram illustrating a content stored in an external storage device shown in FIG. 1.

FIG. 3 is a memory map of a control program and related data that are loaded to a memory as shown in FIG. 1.

FIG. 4 is a diagram illustrating a business form to which a copy-forgery-inhibited pattern is applied so as to be printed according to one exemplary embodiment of the present invention.

FIG. 5 is a diagram illustrating one example of the business form that is obtained by performing a printing of the copy-forgery-inhibited pattern according to this exemplary embodiment to the business form as shown in FIG. 4.

FIG. 6 is a diagram illustrating a combination of the business form described in FIG. 5 and a copy-forgery-inhibited pattern image.

FIG. 7 is a diagram illustrating an interface for setting a margin of the copy-forgery-inhibited pattern image to the business form according to one exemplary embodiment of the present invention.

FIG. 8 is a diagram illustrating a screen for setting the copy-forgery-inhibited pattern according to one exemplary embodiment of the present invention.

FIG. 9 is a diagram illustrating a screen for setting a gradation attribute that is one of copy-forgery-inhibited pattern attributes according to one exemplary embodiment of the present invention.

FIG. 10 is a diagram illustrating each attribute that constitutes a gradation attribute.

FIG. 11 is a diagram illustrating a case where a “direction”, which is one of the gradation attributes illustrated in FIG. 10, is set to “from top to bottom”.

FIG. 12 is a diagram illustrating a case where the direction is set to “from upper left to lower right”.

FIG. 13 is a flow chart illustrating a processing for producing print data based on a setting for a business form container and a copy-forgery-inhibited pattern container associated therewith according to one exemplary embodiment of the present invention.

FIG. 14 is a flow chart illustrating a detailed processing for computing a size of the copy-forgery-inhibited pattern container as shown in FIG. 13.

FIG. 15 is a flow chart illustrating a detailed processing for producing the copy-forgery-inhibited pattern image shown in FIG. 13.

FIG. 16 is a diagram illustrating an image in which character strings are repeatedly shown, which are produced by a latent image producing processing shown in FIG. 15.

FIG. 17 is a diagram illustrating a division of the copy-forgery-inhibited pattern container region shown in FIG. 15 where, as the gradation attributes, a resolution is low, a shape is a rectangle, and the direction is from the upper left to the lower right.

FIG. 18 is a diagram illustrating a mask produced by a mask producing processing shown in FIG. 15.

FIG. 19 is a diagram illustrating a latent image that has only a masked region that is produced by a processing of masking the latent image shown in FIG. 15.

FIG. 20 is a diagram illustrating a method of setting a “link” to a side of a copy-forgery-inhibited pattern container, as another method that allows the copy-forgery-inhibited pattern container to be linked with a business form container, according to an exemplary embodiment of the present invention.

### DETAILED DESCRIPTION OF THE EMBODIMENTS

Exemplary embodiments of the present invention will now be described in detail with reference to the drawings. It should be noted that the relative arrangement of the components, the numerical expressions and numerical values set forth in these exemplary embodiments do not limit the scope of the present invention unless it is specifically stated otherwise.

### First Embodiment

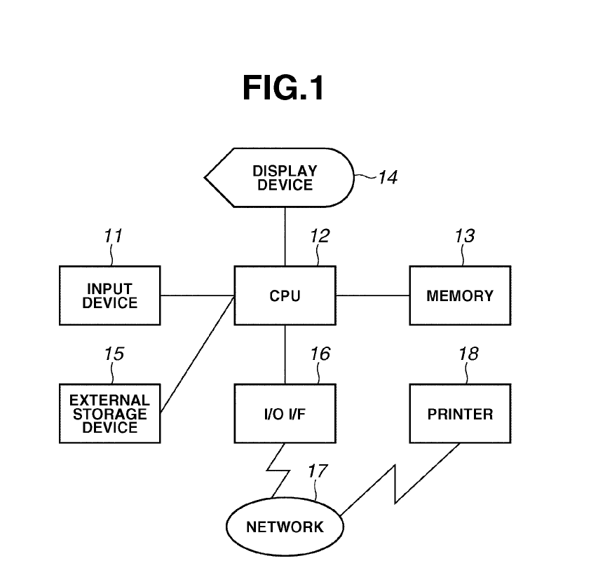

FIG. 1 is a block diagram that describes a hardware configuration of a client in a copy-forgery-inhibited pattern printing system according to a first exemplary embodiment of the present invention.

Referring to FIG. 1, the copy-forgery-inhibited pattern printing system is a computer system that includes a central processing device (i.e., CPU 12), a main storage device (i.e., a memory 13) having a RAM and a ROM, and an external storage device 15 having a floppy disk (FD) and a hard disk (HD).

A main portion of the computer system is configured by an input device 11 having a pointing device such as a keyboard and a mouse, a display device 14 having a CRT display, and an external input/output interface 16 connected to an external network 17.

An image to which a copy-forgery-inhibited pattern produced by the computer system is combined, is printed by a printer 18 connected via the external network 17.

A server and a client of the copy-forgery-inhibited pattern printing system are operated by the CPU executing a basic I/O program, an operating system (OS), and a program.

The basic I/O program is written in the memory 13 and the OS is written in the HD of the external storage device 15.

When the computer system is turned on and an initial program loading (IPL) function of the basic I/O program is executed, the OS is read from the HD of the external storage device 15 to the RAM of the memory 13, and the operation of the OS starts.

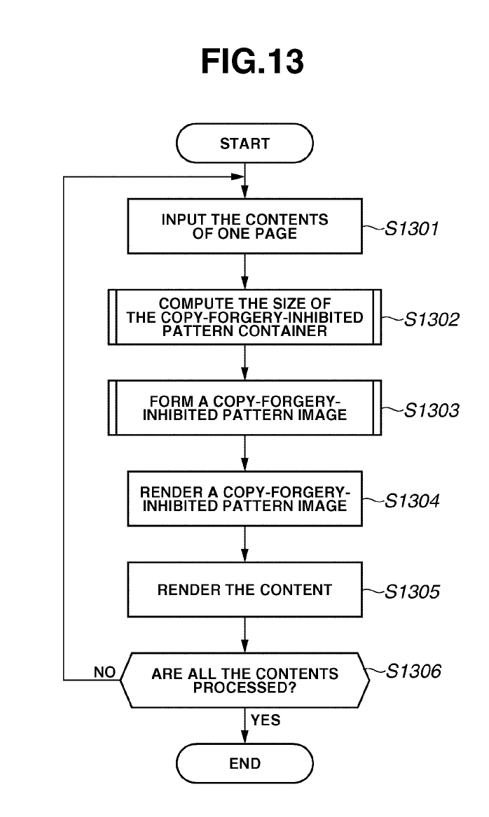

The program is coded in accordance with a flow chart of a processing procedure that is described later with reference to FIG. 13.

In this exemplary embodiment, a control program and related data are stored in the FD of the external storage device 15.

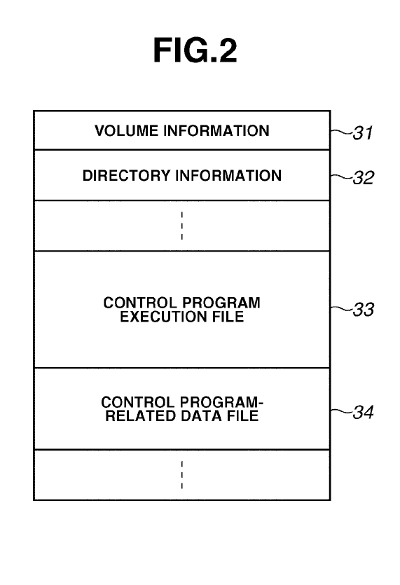

FIG. 2 is a diagram that describes a stored content.

Referring to FIG. 2, the FD stores volume information 31, directory information 32, a control program execution file 33, and a control program-related data file 34.

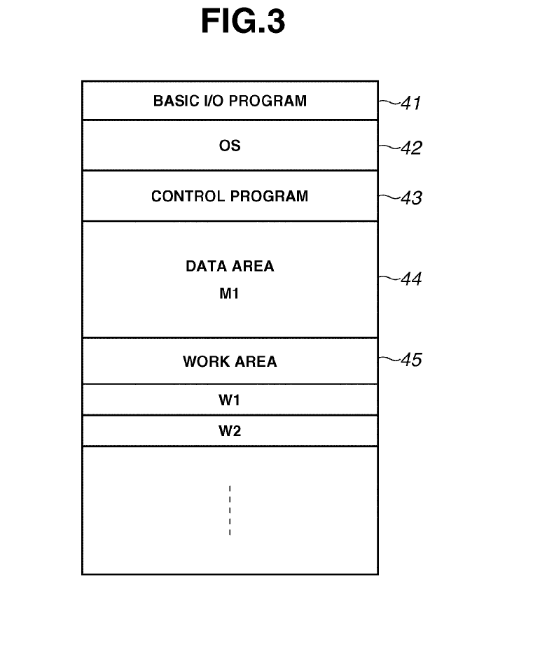

The control program and the related data that are stored in the FD can be loaded to the computer system via an FD drive of the external storage device 15, as shown in a memory map of FIG. 3.

That is, when the FD loaded into the FD drive, the control program 33 and the related data 34 are read from the FD under control of the OS 42 and the basic I/O program 41, and then loaded to the RAM of the memory 13 as a control program 43 and data loaded in a data area 44. Also, RAM 13 has work area 45 which loads data related to the control program 43 temporarily.

In this exemplary embodiment, the control program and the related data are directly loaded to the RAM of the memory 13 and executed. However, the program and the related data can also be stored in the HD of the external storage device 15, and be loaded from the HD.

In addition, a medium that stores the control program can be an optical disk and an IC memory card.

Further, the program can also be stored in a read-only memory (ROM) of the memory 13 and can be directly executed by the CPU 12.

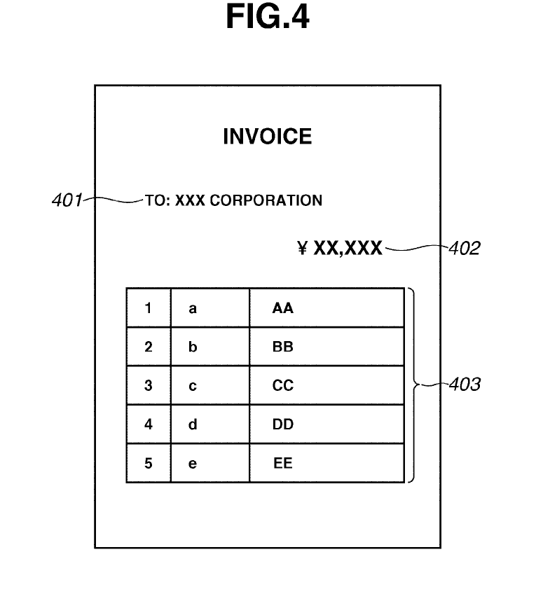

FIG. 4 is a diagram illustrating a business form to which data is inputted by an image processing device of the computer system according to the present exemplary embodiment. A copy-forgery-inhibited pattern is applied to the business form to be printed.

A region of the business form described in the present exemplary embodiment can be changed in accordance with an amount of inputted content.

More specifically, the business form as described in FIG. 4 is configured by an area of a fixed character string “INVOICE”, a “TO: XXX CORPORATION (corporation name)” field 401, an “amount of money” field 402, and a detailed list field 403.

In the business form, the character string “INVOICE”, the character string “TO:” in the corporation name field 401, a symbol “¥” in the money amount field 402, and vertical and horizontal ruling lines that configure a table of the detailed list field 403 are fixed data.

On the other hand, the character string “XXX Corporation” in the corporation name field 401, “XX,XXX” in the money amount field 402, and “a, b, c, d, e, AA, BB, CC, DD, EE” in the detailed list field 403 are variable data.

That is, according to the exemplary embodiment, with respect to the “variable data”, the size and the shape of a region vary when an amount of data to be inputted varies.

In this regard, according to the exemplary embodiment, the size of the region is changed in a direction downward to a bottom of the table in accordance with the amount of variable data inputted into the detailed list field 403.

However, when the amount of variable data inputted to the corporation name field 401 and the money amount field 402 is large, that is, when the amount of data corresponding to “XXX Corporation” and “XX,XXX” is large, the size of the corporation name field 401 and the money amount field 402 can naturally be configured to be variable.

A technology for setting the variable data region, such as the detailed list field 403, is a publicly known technology, and therefore, its description is omitted herein.

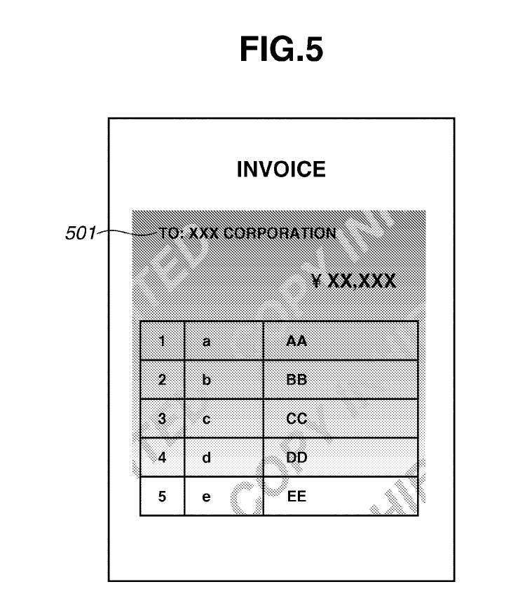

FIG. 5 is a diagram illustrating a result of printing of the business form that is obtained by performing the printing of the copy-forgery-inhibited pattern according to the exemplary embodiment on the business form as shown in FIG. 4.

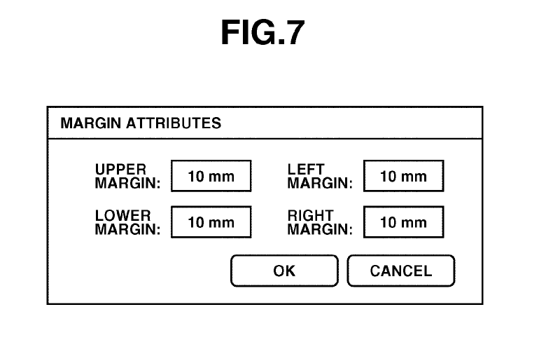

As shown in FIG. 5, the copy-forgery-inhibited pattern image is applied only to region 501. Region 501 is obtained by adding an appropriate margin (the margin will be described below with reference to FIG. 7) to a rectangular region in order to improve the appearance of the business form. The rectangular region includes the corporation name field 401, the money amount field 402, and the detailed list field 403.

The region 501 varies according to the change of the size or the shape of a rendering region of the business form that is caused by the input of the variable data. Thus, the size or the shape of the copy-forgery-inhibited pattern image provided to an image of the business form is finally determined.

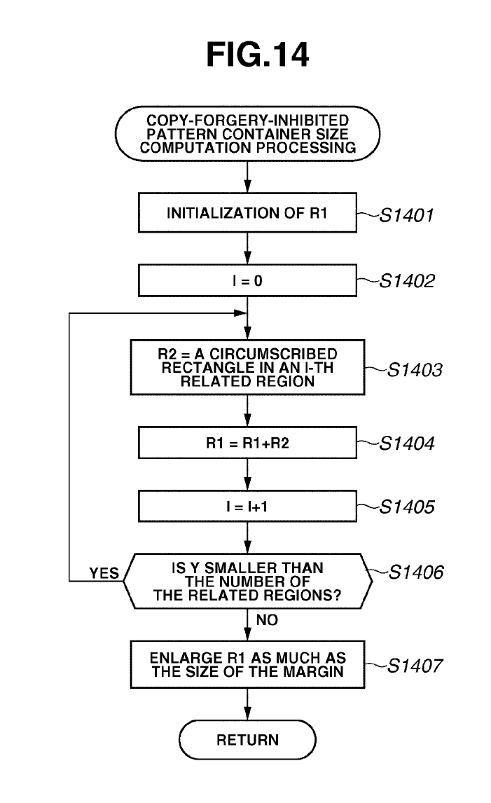

The change of the size of the region made in accordance with the input of the variable data is described below with reference to steps S1403 through S1406 of FIG. 14.

In addition, the copy-forgery-inhibited pattern image is provided with a density gradation.

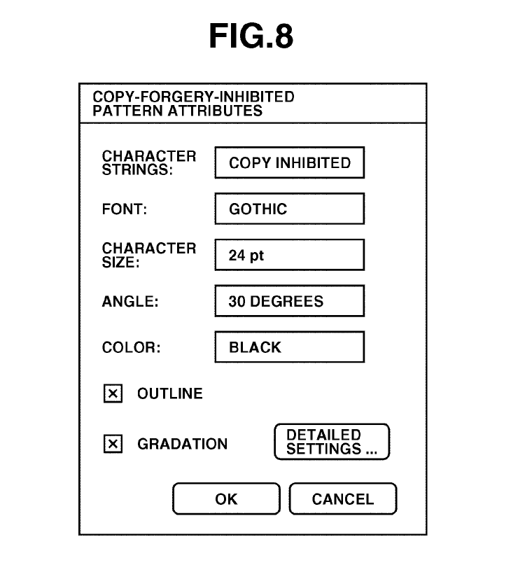

The gradation is implemented in a manner such that the copy-forgery-inhibited pattern is divided into a plurality of continuous regions in a predetermined direction and copy-forgery-inhibited pattern parameters of each region are gradually changed, as described below with reference to FIG. 8.

In the example shown in FIG. 5, the copy-forgery-inhibited pattern image is divided into plural horizontal regions in a downward direction in FIG. 5, and the copy-forgery-inhibited pattern parameters are changed so that the density of each region is gradually reduced.

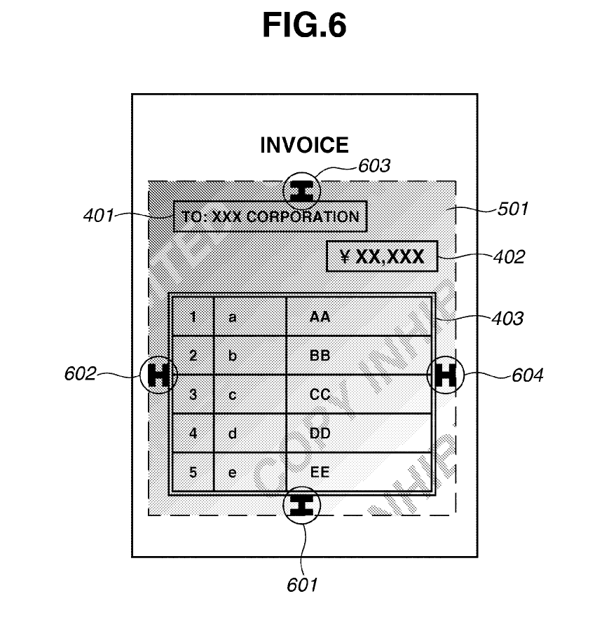

FIG. 6 is a diagram that describes a combination of the business form described in FIG. 5 and the copy-forgery-inhibited pattern image.

The combination of the business form and the copy-forgery-inhibited pattern is performed by producing a “copy-forgery-inhibited pattern container” on a document template as shown in FIG. 4.

Here, the “container” is an area into which the data or the content is inputted. The container includes a fixed container whose frame size is fixed, and a variable container whose frame size is changed in accordance with the size of the data or the content to be inputted.

The copy-forgery-inhibited pattern container is a graphic formed on the document template in which various parameters are set that characterize the region to be printed with the copy-forgery-inhibited pattern and the copy-forgery-inhibited pattern image.

FIG. 6 is a diagram illustrating a state in which the copy-forgery-inhibited pattern container is produced on the document template. The container, namely an object in the field (variable portion) of the business form is also produced on the document plate.

The size and the shape of the copy-forgery-inhibited pattern container in the exemplary embodiment are changed according to the variance of the size and the shape of the container of the business form.

More specifically, this linking is implemented using a dynamic link technology by relating the copy-forgery-inhibited pattern container with the variable container of the business form.

Therefore, a detailed explanation of the linking is omitted herein.

In addition, setting for the linking is performed along with setting of a margin, as described in detail below.

Referring to FIG. 6, the rectangular region 501 is the region for the copy-forgery-inhibited pattern container to which the copy-forgery-inhibited pattern is provided.

That is, first, in the computer system as shown in FIG. 1, the corporation name field 401, the money amount field 402, and the detailed list field 403 are selected.

Then, when a “copy-forgery-inhibited pattern container producing command” is executed, the copy-forgery-inhibited pattern container is produced in a smallest rectangular region (i.e., including no margin) that includes a rectangle of each selected field.

After that, margins 603, 601, 602, and 604, each of which is set in a top, bottom, left, and right portion respectively, are set via an interface for setting a margin attribute as shown in FIG. 7.

When the margin is set, the region of the container of the business form whose size or shape varies in accordance with the variable data is specified, and the linking of the copy-forgery-inhibited pattern container with the container of the business form can be implemented.

That is, the margin is set on the document template by using as a reference the field that is provided at an outermost portion of the business form in its top, bottom, left, and right direction.

In the example as shown in FIG. 6, a lowest line of the detailed list field 403 is set as the reference so as to form the margin 601.

Thus, a lower portion of the copy-forgery-inhibited pattern container is related with the lowest portion of the business form container.

As a result, as the business form is enlarged downward in FIG. 6 due to an increase in the amount of the variable data, the copy-forgery-inhibited pattern image is enlarged accordingly, maintaining the same margin 601.

Also, the margins 602, 603, and 604 are set similarly using a corresponding line of the field as the reference.

In this manner, the size or the shape is automatically changed according to the variance in the size or the shape of the business form, and thus the copy-forgery-inhibited pattern can be appropriately applied to the region of the business form that should be provided with the copy-forgery-inhibited pattern.

As described above, the copy-forgery-inhibited pattern container whose size and shape varies according to the business form container is provided with a copy-forgery-inhibited pattern attribute.

FIG. 8 is a diagram illustrating a screen for setting the copy-forgery-inhibited pattern according to the exemplary embodiment.

The copy-forgery-inhibited pattern attribute includes a character string, a font, a character size, a character angle of the latent image, the color, the presence or absence of an outline, and the presence or absence of the gradation, which characterize the copy-forgery-inhibited pattern image.

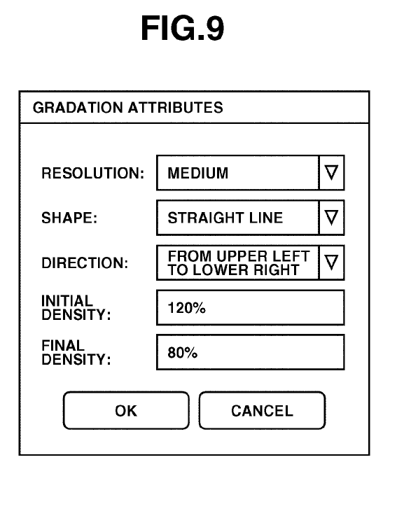

In addition, a detailed gradation attribute is set in a gradation attribute setting screen as shown in FIG. 9. The detailed setting includes a “resolution”, a “shape”, “direction”, an “initial density”, and a “final density”, which characterize a gradation copy-forgery-inhibited pattern.

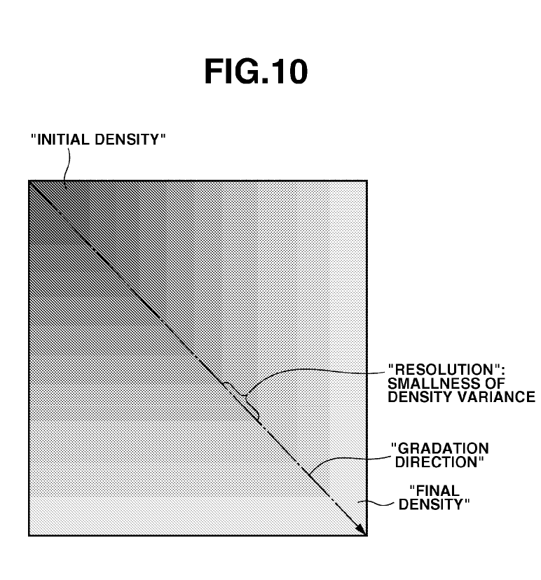

FIG. 10 is a diagram illustrating each attribute of the gradation.

Referring to FIG. 10, the “resolution” indicates a fineness of the variance of density. More specifically, the “resolution” describes how many divided areas are provided in which the density is different.

In the exemplary embodiment, three kinds of settings, “high” (division number is 64), “middle” (division number is 32), and “low” (division number is 16) can be performed.

The “shape” indicates the shape of the copy-forgery-inhibited pattern container region that is divided in the graduated shape. For example, a straight line, a rectangle, and an oval, as shown in FIG. 10, can be set.

The “direction” is determined based on a position at which the gradation starts and a position at which the gradation ends, and differs according to the shape of the gradation.

For example, when the gradation shape is the straight line, the direction such as “from top to bottom”, “from center to top and bottom”, and “from upper left to lower right” can be set. When the gradation shape is the oval, the direction such as “from top to bottom”, “from upper left to lower right”, and “from center to outer portion” can be set.

By using the “initial density” and the “final density”, a ratio to a standard density is set.

The standard density is the density of printing the copy-forgery-inhibited pattern that is set in advance in the case where the gradation copy-forgery-inhibited pattern printing is not performed.

A range where the copying is inhibited is determined by the values of the initial density and the final density.

In the present exemplary embodiment, the copy-forgery-inhibited pattern density gradually becomes small from an initial position of the gradation to a final position of the gradation. When the copy-forgery-inhibited pattern density is too high, a good appearance of the resulting print product cannot be obtained. On the other hand, when the copy-forgery-inhibited pattern density is too low, the latent image vanishes after copying, and thus the copying of the content cannot be inhibited in some portions.

Accordingly, it is desirable not only that the initial density and the final density are set to appropriate values, but that the direction is set in consideration of arrangement of important contents of the direction in which the variable region related to the copy-forgery-inhibited pattern container increases or decreases, or simply of a design of the business form.

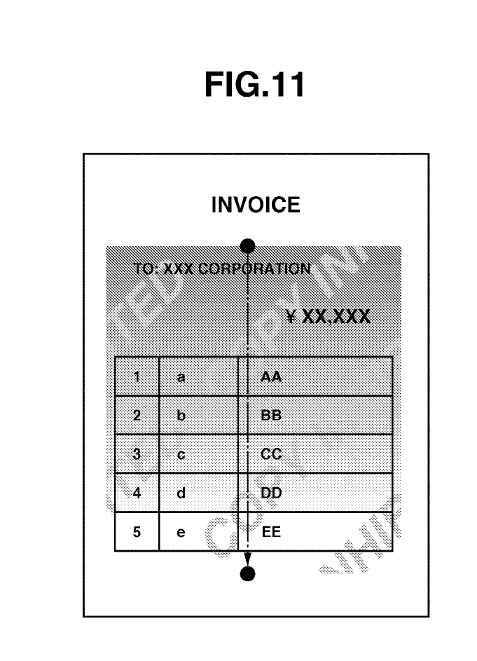

FIG. 11 is a diagram illustrating a case where the direction of the gradation copy-forgery-inhibited pattern is set to “from top to bottom”.

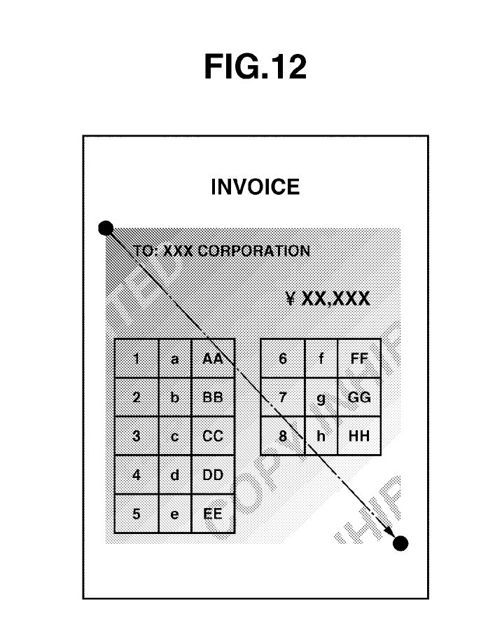

FIG. 12 is a diagram illustrating a case where the direction of the gradation copy-forgery-inhibited pattern is set to “from upper left to lower right”.

In the case of the table where rows end in a middle of a second column, as shown in FIG. 12, when the direction of the gradation copy-forgery-inhibited pattern is set to “from upper left to lower right”, copy inhibition can have only a small effect in the region that includes no content.

As a result, an amount of toner consumption can be suppressed while a risk that the copying cannot be inhibited in some portions is reduced to a minimum.

Thus, the document template on which the copy-forgery-inhibited pattern container is produced and linked to the business form container, is stored in advance in the external storage device 15 or a database that is connected to the external network 17.

FIG. 13 is a flow chart illustrating a processing for producing print data performed based on the setting for the business form container and the copy-forgery-inhibited pattern container which are linked as described above.

First, the variable data of the business form that is a content of one page, is inputted to the document template (step S1301), and a layout of the business form is determined.

At this time, a region size of the detailed list field 403 obtained after the change is specified.

Here, inputting of the variable data is the processing for arranging the input data in the region of each field (for example, the corporation name field 401) of the document template.

With respect to each field, a manner is set in which the input data is arranged.

For example, an input data type to be received, a font and a paragraph break attribute (in the case of character type data), a fitting to the field region in the case of an image attribute, are set.

Next, the size of the copy-forgery-inhibited pattern container of the produced page is computed (step S1302), and the copy-forgery-inhibited pattern image of the obtained size is produced (step S1303).

Then, the produced copy-forgery-inhibited pattern image is rendered (step S1304), and the fixed data and the variable data of the business form are rendered thereon (step S1305).

Then, it is determined whether the variable data of the business form that is not yet processed is present (step S1306). If it is determined that the variable data of the business form that is not yet processed, is present, the processing returns to step S1301, and the processing from step S1301 is repeated until all the contents of the business form are completely processed.

By steps S1304 and S1305 in FIG. 13, a second region can be set to which the copy-forgery-inhibited pattern image is provided. The second region is set according to the variance of the size or the shape of the rendering region of the business form that occurs due to inputting of the variable data.

In addition, the printing data can be produced on the basis of the copy-forgery-inhibited pattern image in the set region as described above, and the image of the business form in the region where the size or the shape varies.

FIG. 14 is a flow chart illustrating detailed processing for computing the size of the copy-forgery-inhibited pattern container in step S1302.

First, a variable R1 that indicates a target region is initialized (step S1401), and then a loop counter I is initialized to be “0” (step S1402).

The variable R1 indicates, for example, the size of the copy-forgery-inhibited pattern container represented by most outer coordinates in a horizontal direction and a vertical direction (longitudinally and latitudinally).

Next, a circumscribed rectangle R2 in an I-th related region is obtained (step S1403).

The size of the circumscribed rectangle R2 is similarly indicated by most outer coordinates in the horizontal direction and the vertical direction.

Then, R1 is obtained by adding R2 to R1 (step S1404)

The resulting sum is indicated by most outer coordinates in the horizontal direction and the vertical direction.

Here, the related region is the region where the graphic and the field are related to the business form container at the time of production of the copy-forgery-inhibited pattern container. The related region is laid out by step S1301.

In the example shown in FIG. 6, the related region is the region of the corporation name field 401 which is related by the margin 603, and the region of the detailed list field 403 which is related by the margins 601, 602, and 604.

Then, the loop counter I is counted up (step S1405). If it is determined that I is smaller than the number of the related regions (step S1406), the related region that is yet to be processed is present. The processing returns to step S1403, the processing after step S1403 is repeated, and a sum of circumscribed rectangle is computed in all the related regions.

As a result, in the example shown in FIG. 6, the variable R1 is the sum of the circumscribed rectangle in the corporation name field 401 and the circumscribed rectangle in the detailed list field 403. That is, with respect to the horizontal direction, the outermost coordinates of the left and right side of the circumscribed rectangle are applied. With respect to the vertical direction, the coordinate at an upper end of the circumscribed rectangle in the corporation name field 401 and the coordinate at a bottom end of the circumscribed rectangle in the detailed list field 403 are applied to the top and bottom portions, respectively.

When the processing is completed for all the related regions in step S1406, the variable R1 is enlarged by the margin that is set to the copy-forgery-inhibited pattern container (step S1407).

With respect to this enlargement, the coordinates obtained by adding the margin in both the horizontal and vertical directions become the variable R1.

Then, the variable R1 obtained as a result of the enlargement becomes the size of the copy-forgery-inhibited pattern container.

In the example shown in FIG. 6, the area 501 is the region of the copy-forgery-inhibited pattern image indicated by the variable R1.

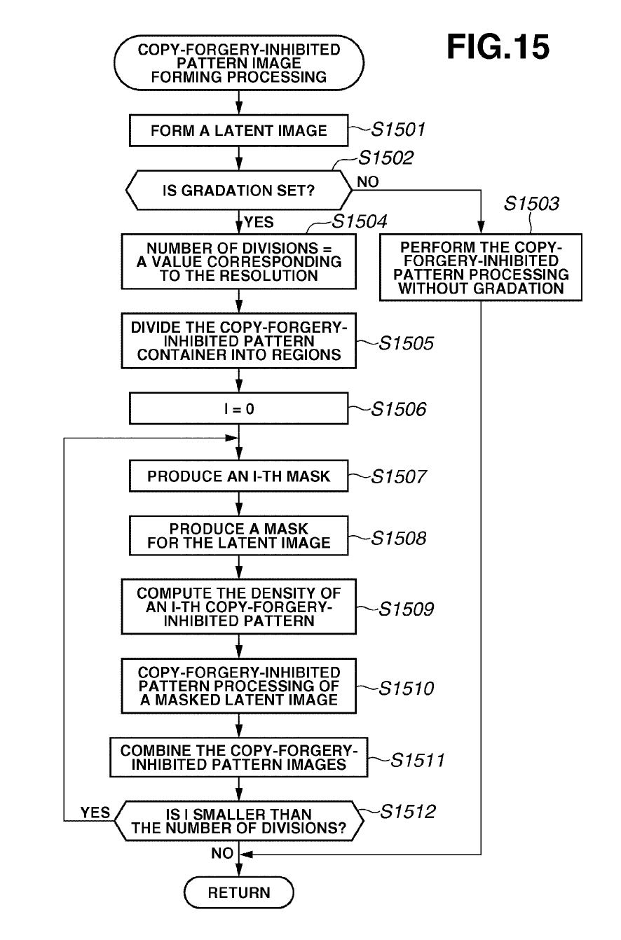

FIG. 15 is a flow chart illustrating a detailed processing for producing the copy-forgery-inhibited pattern image in step S1303 as described in FIG. 13.

First, on the basis of the copy-forgery-inhibited pattern attribute that is set to the copy-forgery-inhibited pattern container, the latent image of the size of the copy-forgery-inhibited pattern container computed by step S1302, that is, the image that appears at the time of copying, is produced (step S1501).

The processing is the same as the conventional processing of producing the latent image, therefore, the detailed description is omitted herein.

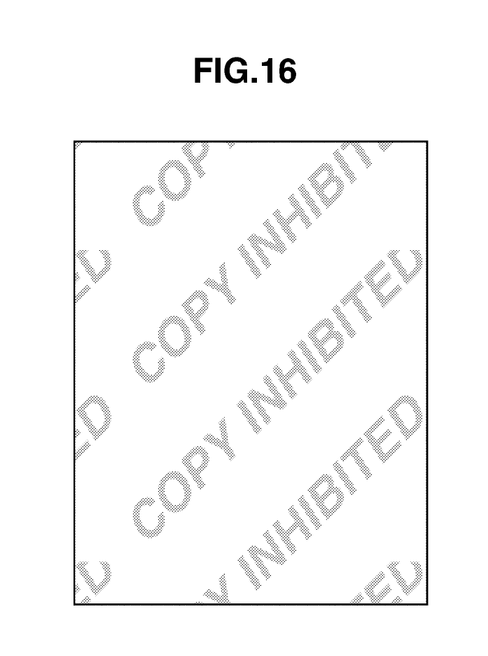

By the processing, the image is produced in which the character strings, for example, are repeated as the latent image shown in FIG. 16.

Next, it is determined whether the gradation is set to the copy-forgery-inhibited pattern attribute that is set to the copy-forgery-inhibited pattern container (step S1502).

If it is determined that the gradation copy-forgery-inhibited pattern is not set, the processing for the copy-forgery-inhibited pattern without a gradation is performed on the latent image, and the subject image is produced (step S1503) . Then the processing ends.

If it is determined that the gradation is set to the copy-forgery-inhibited pattern, the number of divisions corresponding to the resolution of the copy-forgery-inhibited pattern attribute set to the copy-forgery-inhibited pattern container is computed (step S1504).

In the present exemplary embodiment, three kinds of resolution settings, high, middle, and low, can be set. The number of divisions is set in advance. That is, “high” corresponds to 64 divisions, “middle” corresponds to 32 divisions, and “low” corresponds to 16 divisions.

Alternatively, a fixed interval can be determined in accordance with the resolution, and the length of the copy-forgery-inhibited pattern container in the direction of the gradation is divided by the interval so that its result can be used as the number of divisions.

Next, the region is obtained in which a portion from the initial point to a final point determined by the gradation direction of the copy-forgery-inhibited pattern region is divided by the number of divisions in accordance with the shape of the gradation similarly determined (step S1505).

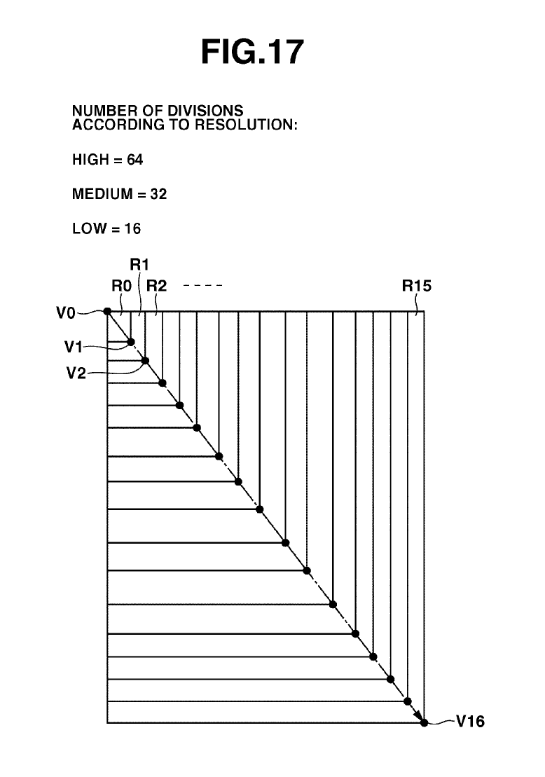

FIG. 17 is a diagram illustrating an example of the division of the copy-forgery-inhibited pattern container region in the case where the gradation attributes are such that the resolution is low, the shape is a rectangle, and the direction is from the upper left to the lower right.

A diagonal line extending from an upper-left point (the initial point) of the copy-forgery-inhibited pattern container region to a lower-right point (the final point) is divided into sixteen portions, and the dividing points are V0, V1 . . . V16 in this order from the initial point to the final point.

Then, sixteen rectangles each having a diagonal line V0-Vn (n is an integer from 1 to 16) are R0, R1, . . . R15 in this order, respectively.

The method of dividing the regions differs according to the shape of the gradation.

For example, when the shape of the gradation is oval, regions are divided using a quarter elliptical arc circumscribing R0 to R15 used in the case of rectangle.

Returning to FIG. 15, after the copy-forgery-inhibited pattern container region is divided by the number of divisions, the loop counter is initialized to be “0” (step S1506).

Then, an I-th mask Mi (i is equal to 0 through (the number of divisions −1)) is produced (step S1507).

The mask Mi is the region obtained by subtracting a rectangle R (i−1) from a rectangle Ri (i is equal to 1 through (the number of divisions −1)).

Note here that a zero-th mask M0 is for R0.

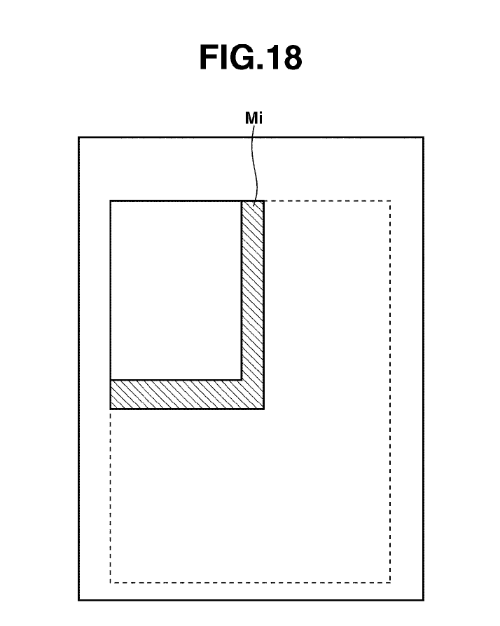

In the example shown in FIG. 17, each of the masks M1 through M15 has a shape of a reversed-L as shown in FIG. 18.

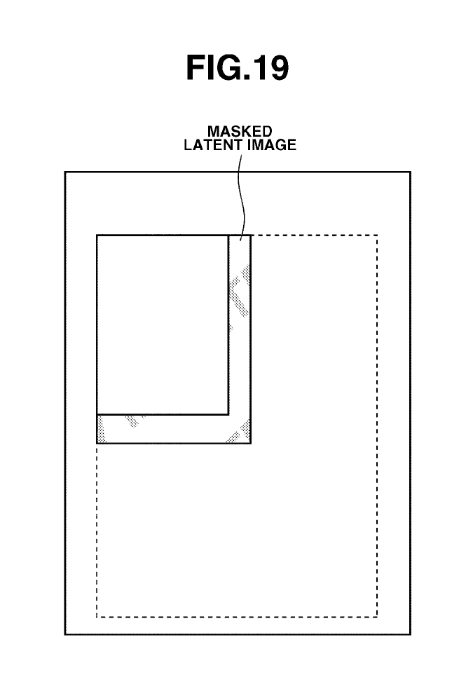

After the mask Mi is produced, a latent image having only a mask region is produced by providing the mask Mi to the latent image, as shown in FIG. 19 (step S1508).

Then, an I-th density of the copy-forgery-inhibited pattern is computed (step S1509), then the copy-forgery-inhibited pattern processing is performed on the image produced by step S1508 using the computed density (step S1510).

The I-th copy-forgery-inhibited pattern density is computed by an expression described below.
Density (I)=initial density−(initial density−final density)×I/number of divisions.

In the copy-forgery-inhibited pattern processing, the latent image is formed using large dots and the other portion is formed using small dots so as to produce the copy-forgery-inhibited pattern image with the obtained density.

The processing is the same as the conventional processing of producing the copy-forgery-inhibited pattern image, therefore, the detailed description is omitted herein.

Next, the combination with the copy-forgery-inhibited pattern image produced in the manner described above is performed (step S1511).

Since each mask Mi is not overlapped, there is no overlapping portion in the combination processing.

Then, in step S1512, while “I” is smaller than the number of divisions, the processing after step S1507 is repeated on the latent image that is not yet processed until the copy-forgery-inhibited pattern processing is performed on the latent images of all the regions.

As a result, the gradation copy-forgery-inhibited pattern image of the copy-forgery-inhibited pattern container region is produced.

By providing the gradation to the copy-forgery-inhibited pattern, even under different copying conditions, for example, when the kind of the copying machine or the copying density of the copying machine is different, some of the densities at each level of the gradation can match the above copying conditions.

Thus, the latent image can be clearly reproduced when printed so as to provide an effective copy inhibition to the copied product.

The data of the image thus obtained by combining the copy-forgery-inhibited pattern with the business form linked therewith as described above, is in a data format that can be transferred to and printed by the printer 18 (FIG. 1).

Thus, a printing result can be obtained such that the copy-forgery-inhibited pattern is appropriately arranged especially corresponding to the variance of the size of the business form.

### Second Embodiment

In the above first exemplary embodiment, the configuration is described in which the margin can be set through the setting screen as shown in FIG. 7.

However, the margin need not necessarily be set. That is, the margin can be fixed or the graphics and the fields related to the business form container can be made the same as the region laid out by step S1301.

### Third Embodiment

In the exemplary embodiments described above, the business form is described as an example of the image whose size or shape can be varied according to the input of the variable data. However, the present invention is not limited to an image provided in advance with a frame of ruled lines and formed by inputting the data in spaces between the ruled lines.

For example, the copy-forgery-inhibited pattern printing to which the present invention is applied, can be performed on a document such as meeting minutes, where the amount of data described on one page is not fixed

### Additional Embodiments

In the exemplary embodiments described above, the copy-forgery-inhibited pattern container is linked with the business form container by the setting of the margin. However, the method of the linking is not limited to this method, and any linking method that would enable practice of the present invention is applicable.

For example, a “link” is set to a side of the copy-forgery-inhibited pattern container.

The link can be set when one side of the copy-forgery-inhibited pattern container is related with one side of the business form region using a pointing device, such as a mouse, so as to set a distance in a horizontal or a vertical direction.

The distance set to the link is equivalent to the margin in the exemplary embodiments as described above.

The side to which no link is set, is positionally fixed to the paper.

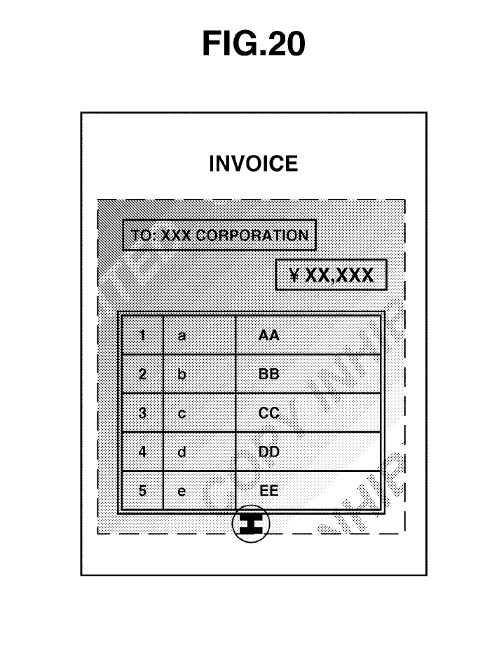

In the example shown in FIG. 20, a bottom side of the copy-forgery-inhibited pattern container is set to always be at a constant distance from the bottom side of the field of the “the detailed list” field in the vertical direction.

Thus, when the number of rows of the detailed list field increases, the top, the left, and the right sides of the copy-forgery-inhibited pattern container are placed at fixed positions, and the bottom side of the copy-forgery-inhibited pattern container is extended downwards.

The link can be set to a plurality of sides of the copy-forgery-inhibited pattern container, and a plurality of links can also be set to the same one side.

When a plurality of links are set to the same one side, an outermost position among the side positions to the extent that each link is effective to the side is determined to be the region of the copy-forgery-inhibited pattern container.

The present invention can also be achieved by providing the system or the device with a program code of software implementing the function of the exemplary embodiments and by reading and executing the program code stored in the storage medium with a computer of the system or the device (the CPU or the MPU).

In this case, the program code as shown in FIGS. 13 through 15 itself implements the function of the exemplary embodiments mentioned above.

Accordingly, the program code itself and a unit for supplying the program code to the computer, namely, the storage medium storing the program code, for example, constitute the present invention.

As the storage medium for supplying such program code, a floppy disk, a hard disk, an optical disk, a magneto-optical disk, a CD-ROM, a magnetic tape, a nonvolatile memory card, a ROM, and the like can be used.

In addition, present invention can be implemented not only by executing the program code read by the computer, but also implemented by the processing in which an OS or a combination of the OS and other application software carries out a part of or the whole of the actual processing on the basis of the instruction given by the program code. In this case, the program code constitutes the exemplary embodiments of the present invention.

Further, after the supplied program code is written in a memory provided in a function enhancing board inserted in the computer or a function enhancing unit connected to the computer, the CPU and the like provided in the function enhancing board or the function enhancing unit carries out a part of or the whole of the processing to implement the function of the exemplary embodiments as described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-274430 filed Sep. 21, 2005, which is hereby incorporated by reference herein in its entirety.

What is claimed is:

1. An image processing apparatus that produces data for printing, wherein the data is based on an image in a first region whose size and shape can vary according to an input of variable data and on a copy-forgery-inhibited pattern which is added to the image, the apparatus comprising:
a region setting unit adapted to set a second region to which a copy-forgery-inhibited pattern image is provided, wherein the second region is linked to the variance in size or shape of the first region; and
a production unit adapted to produce data for printing based on the copy-forgery-inhibited pattern image in the second region set by the region setting unit and an image in the first region whose size or shape is varied.

2. The image processing apparatus according to claim 1, wherein the second region includes at least the first region and is based on the first region.

3. The image processing apparatus according to claim 1, wherein the production unit provides a gradation copy-forgery-inhibited pattern image showing a plurality of density that varies stepwise to a latent image of the copy-forgery-inhibited pattern image.

4. The image processing apparatus according to claim 1, wherein the region setting unit sets the second region to be variable by setting a margin to the first region, and wherein the margin is maintained as an interval between the first region and the second region.

5. The image processing apparatus according to claim 1, wherein the first region includes a predetermined region whose size and shape varies according to an input of variable data, and
the production unit, after the variable data is inputted to the predetermined region, computes a size of the second region linked to the variance of the predetermined region and produces the copy-forgery-inhibited pattern image of a computed size so as to include the produced copy-forgery-inhibited pattern image in print data.

6. The image processing apparatus according to claim 5, wherein the size of the second region is computed such that a sum of a plurality of the predetermined regions related to the copy-forgery-inhibited pattern image in the first region is obtained and the second region is enlarged based on the margin.

7. The image processing apparatus according to claim 3, wherein the production unit produces the latent image of a computed size, computes a number of divisions based on a set resolution of a gradation copy-forgery-inhibited pattern image, divides the second region corresponding to the copy-forgery-inhibited pattern image by the computed number of divisions, produces a mask per each divided region, performs a processing for masking the latent image using the produced mask, computes a density of the copy-forgery-inhibited pattern, produces the copy-forgery-inhibited pattern image in the computed density using a masked latent image, and performs a combination with the produced copy-forgery-inhibited pattern image.

8. An image processing apparatus that produces data for printing, wherein the data is based on an image in a first region whose size or shape can vary according to an input of variable data and on a copy-forgery-inhibited pattern which is added to the image, the apparatus comprising:
a production unit adapted to produce data for printing based on a copy-forgery-inhibited pattern image in a region linked to the variance in size or shape of the first region, and an image in the fist region whose size or shape is varied.

9. An image processing method for producing data for printing, wherein the data is based on an image in a first region whose size and shape can vary according to an input of variable data and on a copy-forgery-inhibited pattern which is added to the image, the method comprising:
setting a second region to which a copy-forgery-inhibited pattern image is provided, wherein the second region is linked to the variance in size or shape of the first region; and
producing data for printing based on the copy-forgery-inhibited pattern image in the second region and an image in the first region whose size or shape is varied.

10. The image processing method according to claim 9, wherein the second region includes at least the first region and is based on the first region.

11. The image processing method according to claim 9, wherein a gradation copy-forgery-inhibited pattern image showing a plurality of density that varies stepwise is provided to a latent image of the copy-forgery-inhibited pattern image.

12. The image processing method according to claim 9, wherein the second region is set to be variable by setting a margin to the first region, and
wherein the margin is maintained as an interval between the first region and the second region.

13. The image processing method according to claim 9, wherein the first region includes a predetermined region whose size and shape varies according to an input of variable data, and
producing data for printing includes computing, after the variable data is inputted to the predetermined region, a size of the second region linked to the variance of the predetermined region, producing the copy-forgery-inhibited pattern image of a computed size so as to include the produced copy-forgery-inhibited pattern image in print data.

14. The image processing method according to claim 13, wherein the size of the second region is computed such that a sum of a plurality of the predetermined regions related to the copy-forgery-inhibited pattern image in the first region is obtained and the second region is enlarged based on the margin.

15. The image processing method according to claim 11, wherein producing data for printing includes producing the latent image of a computed size, computing a number of divisions based on a set resolution of a gradation copy-forgery-inhibited pattern image, dividing the second region corresponding to the copy-forgery-inhibited pattern image by the computed number of divisions, producing a mask per each divided region, performing a processing for masking the latent image using the produced mask, computing a density of the copy-forgery-inhibited pattern, producing the copy-forgery-inhibited pattern image in the computed density using a masked latent image, and performing a combination with the produced copy-forgery-inhibited pattern image.

16. Computer-executable process steps stored on a computer-readable storage medium, the computer-executable process steps causing a computer to execute the method of claim 9.

17. An image processing method for producing data for printing, wherein the data is based on an image in a first region whose size or shape can vary according to an input of variable data and on a copy-forgery-inhibited pattern which is added to the image in the first region, the method comprising:
producing data for printing based on a copy-forgery-inhibited pattern image in a region linked to the variance in size or shape of the first region and an image in the fist region whose size or shape is varied.

18. Computer-executable process steps stored on a computer-readable storage medium, the computer-executable process steps causing a computer to execute the method of claim 16.
